(19) United States
(12) Patent Application Publication
(10) Pub. No.: US 2023/0055120 A1
(43) Pub. Date: Feb. 23, 2023

(54) MULTI-PASS CATALYTIC CONVERTER

(71) Applicant: Pinnacle Engines, Inc., San Carlos, CA (US)

(72) Inventors: Michael Willcox, Redwood City, CA (US); Simon Jackson, Redwood City, CA (US); Brede Kolsrud, San Mateo, CA (US)

(73) Assignee: Pinnacle Engines, Inc., San Carlos, CA (US)

(21) Appl. No.: 17/893,189

(22) Filed: Aug. 23, 2022

Related U.S. Application Data
(60) Provisional application No. 63/226,173, filed on Jul. 28, 2021.

(51) Int. Cl. F01N 3/20; F01N 3/28

(52) U.S. Cl. CPC F01N 3/2006; F01N 3/2803

(57) ABSTRACT

A multi-pass catalytic converter can divide a catalyst block into several catalytic volumes and enable the exhaust gas to flow through each volume in two or more passes consecutively. As the exhaust gas in an early pass can emit sensible thermal energy and chemical reaction energy to preheat the remaining catalytic volumes via conductive heat transfer, it can shorten the catalyst light-off time for the later passes and the whole catalyst block. By recouping the previously lost dissipating heat from the early catalytic volume, the present disclosure can significantly reduce the catalyst light-off time and emission concentration. Furthermore, one or more mixing chambers can be utilized to thoroughly mix the exhaust gas.

### CROSS-REFERENCES TO RELATED APPLICATIONS

This application claims the benefit of U.S. Provisional Patent Application No. 63/226,173, entitled “MULTI-PASS CATALYTIC CONVERTER,” filed Jul. 28, 2021, which is incorporated herein by reference for all purposes.

### TECHNICAL FIELD

The disclosure generally relates to a system and method for optimizing a catalytic converter in an internal combustion engine. Particularly, the disclosure relates to catalytic converters used in lean-burn internal combustion engines.

### BACKGROUND

To protect the environment and comply with the relevant laws, catalytic converts have been adopted to reduce pollutants in the exhaust gas. Major pollutants include unburned hydrocarbons (HC), carbon monoxide(CO), nitrogen oxides(NOx). Generally, a two-way catalytic converter utilizes precious-metal catalysts such as Platinum (Pt) and Palladium (Pd) to facilitate oxidation of HC to less-harmful CO₂ and H₂O. It also enables oxidation of CO to CO₂. A three-way catalytic convert further utilizes precious catalyst metals such as Rhodium (Rd) to facilitate the reduction of NOx to nitrogen (N₂) and oxygen (O₂).

A precious-metal catalyst in an internal combustion (IC) engine has a reaction efficacy curve substantially based on the incoming gas temperature and the surface temperature of the catalyst. The catalyst light-off temperature is the minimum temperature necessary to initiate the catalytic reaction. Usually, a precious-metal catalyst needs to reach its operating temperature (“light-off temperature”) to maximize its performance. Accordingly, the precious-metal catalyst's performance deteriorates at low temperature, e.g., during engine cold start and warm up, or with relatively cool exhaust gas in a lean-burn engine.

Prior art approaches in increasing the catalyst temperature include thermal barriers such as exhaust heat wrap and metal heat shields. Such thermal barriers also prevent overheating of the nearby components. One problem with the prior art approaches is a low-temperature or unevenly-mixed exhaust gas could not warm up the catalyst quick enough to reach its light-off temperature. This is because a low-temperature or unevenly-mixed exhaust gas could not provide enough thermal energy to quickly activate the catalyst.

Another problem with the prior art approaches is inherent to lean-burn internal combustion engines such as opposed piston engines. The unburned hydrocarbons (HC) from the combustion cylinder are poorly mixed during an exhaust stroke of the combustion cycle.

Specifically, during an early stage of the exhaust stroke, the early HC trapped in small crevices near the valve tips or cylinder head and spark plug vicinity constitute the major mass of the exhaust gas. During the blowdown or bulk stage of the exhaust stroke, the blowdown HC mass is low in lean-burn engines but can be high in stoichiometric engines if poor mixing exists. During a late stage of the exhaust stroke, the late HC include 1) piston crevice mass that was hidden from the combustion but has returned to the cylinder, and 2) unburned HC mass that was furthest from the spark plugs.

As shown in FIG. 1A, the HC v. crank angle profile can show the fluctuate and uneven flow of unburned HC during an exhaust stroke. For example, the blowdown HC is approximately 700 PPM, and the late HC is approximately 6200 PPM.

Moreover, because the hydrocarbons are locally concentrated and not evenly mixed, the “packet” of hydrocarbons may reside inside a catalyst, or be purged out without fully reactions within the catalyst. As shown in FIG. 1B, the flow dynamics of the exhaust event indicates that the mass flow rate reaches its highest level between ˜100 degree to 360 degree crank angel and remains stagnant throughout the rest of the cycle. Accordingly, if the above 6200 PPM HC resides just upstream or downstream of a catalyst, it does not have any residence time internally to react, which renders the catalyst ineffective.

Multiple prior art solutions have been explored to address these light-off issues. One solution is to have a large-volume catalyst. However, it is cost inhibitive to adopt the large catalyst, particularly for a single piston engine. Another solution is to use a mixer to blend the exhaust gas. However, even though the mixer enables the crank-angle-resolved HC profile flat at the average HC measure, the thermal loss of the mixing causes a significant drop in temperature for approximately 20-40 degrees EGT (Exhaust Gas Temperature), which has an adverse effect on the HC conversion. In addition, the additional mixer adversely reduces the exhaust gas pressure.

Thus, it is needed to provide an efficient approach to significantly reduce catalyst light-off time and emission concentrations, particularly for a lean-burn combustion engine.

### SUMMARY

The present subject matter is related to a thermal management method of catalytic converters. According to some embodiments, a catalyst block can be divided into several catalytic volumes or chambers, enabling the exhaust gas to flow through such volumes in two or more passes consecutively. As the exhaust gas in an early pass can emit sensible thermal energy and chemical reaction energy to preheat the remaining catalytic volumes via conductive heat transfer, it can shorten the light-off time for the later passes and the whole catalyst block. Furthermore, via the bi-directional heat transfer, the remaining catalytic volumes can emit heat to increase or maintain the temperature in the early catalytic volume. By recouping the previously-lost dissipating heat of the early catalytic volume, the present disclosure can significantly reduce the catalyst light-off time and emission concentration.

Furthermore, by enabling the exhaust gas to revert or change its flow direction for one or more times, the multi-pass catalytic converter can blend the unevenly distributed hydrocarbons to improve the catalyst's efficiency. It can implement the function of an additional mixer without causing a significant temperature drop of the EGT.

According to some embodiments, the one or more divided catalytic volumes can be parts of a homogenous catalyst block that contains the same type and density of catalyst support or core, washcoat, and precious catalyst metals. According to some embodiments, to maximize the thermal and mixing benefits, different catalytic volumes can utilize tailored specifications. For example, a first catalytic volume can adopt a more porous catalyst support, e.g., a permeable ceramic monolith, to facilitate the flow of the exhaust gas into the remaining catalytic volumes. Similarly, different types and density of precious catalyst metals can be utilized in different catalytic volumes or regions. For example, a first catalytic volume in the first pass can be 200 CPSI (cell per square inch), whereas the second or later catalytic volumes in the later passes can be 300 CPSI to reduce net backpressure and to increase catalyst efficiency.

According to some embodiments, a dual-pass catalytic converter can comprise an elongated converter housing having an upstream terminal and a downstream terminal; a catalyst block placed in the elongated converter housing, the catalyst block having a first diameter; an inlet pipe being substantially in close contact with a surface of an inner catalytic volume of the catalyst block, the inlet pipe having a second diameter that is smaller than the first diameter, wherein the multi-pass catalytic converter is configured to enable the exhaust gas to enter the catalyst block via the inlet pipe at the upstream terminal; enable, in a first pass, the exhaust gas to flow through and react with the inner catalytic volume of the catalyst block; and enable, in a second pass, the exhaust gas to revert, flow through and react with an outer catalytic volume of the catalyst block, the outer catalytic volume being disposed between the inner catalytic volume and the elongated converter housing.

According to some embodiments, thermal sensible energy from the exhaust gas and chemical reaction energy from catalytic reactions in the inner catalytic volume can be used to increase a temperature of the outer catalytic volume. According to some embodiments, the outer catalytic volume can emit heat to maintain the temperature of the inner catalytic volume.

According to some embodiments, the dual-pass catalytic converter is configured to further mix the exhaust gas to improve the conversion efficiency of the catalytic converter. According to some embodiments, the dual-pass catalytic converter can comprise a mixing chamber configured to revert and mix the exhaust gas after the first pass. The mixing chamber can be placed before or after a catalytic volume, or between two catalytic volumes.

According to some embodiments, the inner catalytic volume and the outer catalytic volume can have the same material specifications. According to some embodiments, different catalytic volumes can adopt respective and suitable material specifications to optimize the mixing and heating effect.

According to some embodiments, a tri-pass catalytic converter comprises: an elongated converter housing having an upstream terminal and a downstream terminal; a catalyst block placed in the elongated converter housing, the catalyst block comprising a first catalytic volume, a second catalytic volume, and a third catalytic volume; an inlet pipe being substantially in close contact with a surface of the first catalytic volume, wherein the multi-pass catalytic converter is configured to enable exhaust gas to enter the catalyst block via the inlet pipe at the upstream terminal; enable, in a first pass, the exhaust gas to flow through and react with the first catalytic volume; enable, in a second pass, the exhaust gas to revert, flow through, and react with the second catalytic volume; and enable, in a third pass, the exhaust gas to revert, flow through, and react with the third catalytic volume of the catalyst block.

According to some embodiments, the sensible thermal energy and chemical reaction energy released in the first catalytic volume can preheat at least one of the second catalytic volume and the third catalytic volume. According to some embodiments, the tri-pass catalytic converter further comprises one or more mixing chambers configured to revert and mix the exhaust gas. The one or more mixing chambers can be placed before or after a certain catalytic volume.

According to some embodiments, a multi-pass catalytic converter comprises an elongated converter housing and a plurality of catalytic volumes respectively disposed within the elongated converter, the plurality of catalytic volumes comprises at least one early catalytic volume and at least one late catalytic volume, wherein thermal energy released by the exhaust gas in the at least one early catalytic volume can preheat the at least one late catalytic volume so that its light-off time is reduced.

According to some embodiments, a method of thermal management in a multi-pass catalytic converter comprises: dividing a catalyst block into a plurality of catalytic volumes, the plurality of catalytic volumes comprises at least one early catalytic volume and at least one late catalytic volume; and enabling exhaust gas to flow through the at least one early catalytic volume respectively and the at least one late catalytic volume, wherein thermal energy released by the exhaust gas in the at least one early catalytic volume can preheat the at least one late catalytic volume, wherein the thermal energy released by the exhaust gas comprises thermal sensible energy of the exhaust gas and the chemical reaction energy in the at least one early catalytic volume.

Details of one or more implementations are set forth in the accompanying drawings and the description below. Other features, aspects, and potential advantages will be apparent from the description and drawings, and from the claims.

### DESCRIPTION OF DRAWINGS

FIGS. 1A and 1B are exemplary charts showing issues in the conventional catalytic converters;

FIG. 2 illustrates an embodiment of a lean-burn opposed piston engine;

FIG. 3 illustrates an embodiment of a dual-pass catalytic converter for treating exhaust gas from an internal combustion engine;

FIG. 4 illustrates an embodiment of a tri-pass catalytic converter for treating exhaust gas from an internal combustion engine;

FIG. 5 is an example flow diagram illustrating one embodiment of the present subject matter;

FIG. 6 is another example flow diagram illustrating another embodiment of the present subject matter; and

FIG. 7 illustrates an embodiment of a multi-pass catalytic convert in connection with an internal combustion engine and a muffler system.

### DETAILED DESCRIPTION

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

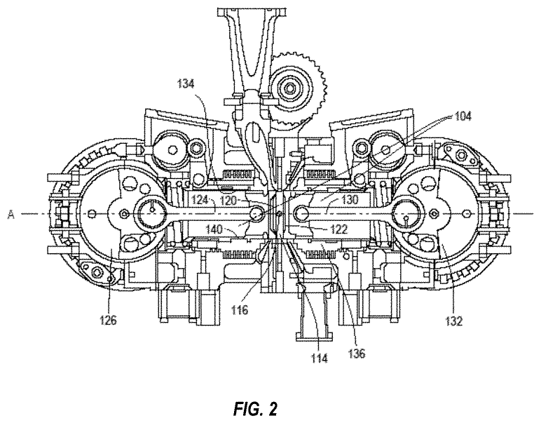

FIG. 2 illustrates a learn-burn opposed piston engine that includes two pistons that share a common cylinder and form a combustion volume defined by the pistons and the walls of the cylinder. Other engine configurations, such as for example those in which each piston is disposed in a separate cylinder whose combustion volume is formed by the piston, a cylinder head, and the walls of the cylinder, are also within the scope of the current subject matter.

As shown in FIG. 2, the opposed piston engine is configured such that a left piston 120 and a right piston 122 reciprocate within a cylinder 104 along a centerline A of the cylinder 104. The left piston 120 is connected to a left connecting rod 124, which in turn connects to a left crankshaft 126. The right piston 122 is connected to a right connecting rod 130, which in turn connects to a right crankshaft 132. The left piston 120 reciprocates within the cylinder 104, and is slidably movable to the left and right along the cylinder wall 134. The right piston 122 also reciprocates within the cylinder 104, and is slidably movable to the left and right along the cylinder wall 134.

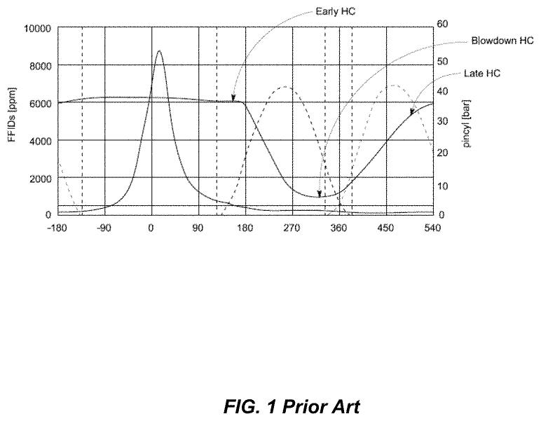

FIG. 2 also illustrates a sleeve valve body 140 that can be slidably movable to the left and right (from the FIG. 1 perspective), such as relative to an oil-path defining piece 136. The left piston 120 and right piston 122 are disposed in the cylinder 104 as they would be at Top Dead Center (TDC), with the combustion volume, which is defined by the cylinder wall 134, the valve seat 114, and the piston heads of the left piston 120 and right piston 122, at its smallest. An engine can be configured such that the ignition timing occurs either at, before, or after the minimum combustion volume.

As shown in FIG. 2, a lean-burn opposed piston engine burns fuel with an excess of air/oxygen. The excess air/oxygen in the lean-burn engine generally emits less hydrocarbons than a rich-burn IC engine. But the unburned hydrocarbons in the lean-burn engine is not evenly mixed as discussed herein.

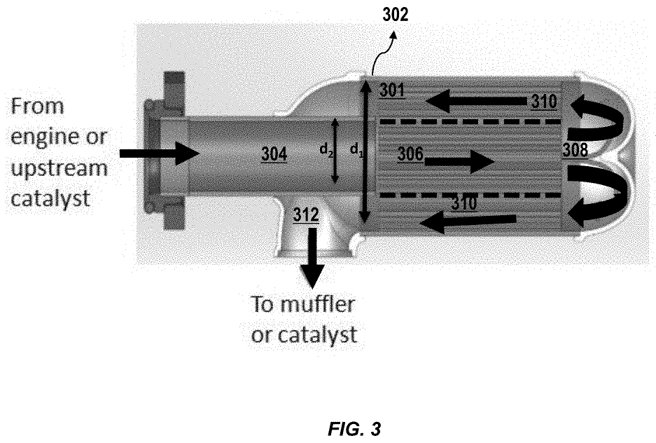

FIG. 3 illustrates a dual-pass catalytic converter 300 for treating exhaust gas from an internal combustion engine. According to some embodiments, a dual-pass catalytic converter 300 comprises a catalyst block 301 placed in an elongated converter housing 302. The elongated converter housing 302 has an upstream terminal close to the IC engine and a downstream terminal opposite to the upstream terminal. The exhaust gas from an IC engine can enter the converter 300 via an inlet pipe 304 and exit it via an outlet pipe 312.

According to some embodiments, a heat shield (not shown) can cover all or part of the elongated converter housing 302. The heat shield can prevent undesired thermal loss of the catalyst and protect nearby components from overheating.

As shown in FIG. 3, a diameter d2 of the inlet pipe 304 can be smaller than a diameter d1 of the catalyst block 301. An exhaust opening of the inlet pipe 304 can be in direct contact with a surface of the catalyst block 301 so that the exhaust gas can flow through the catalyst block via an air path defined by the shape and size of the inlet pipe 304. As an alternative, the inlet pipe 304 can be substantially in close contact with the catalyst block as long as the exhaust gas pressure can be mostly maintained.

According to some embodiments, the inlet pipe 304 can be placed along a center axis of the catalyst block 301. Accordingly, an inner catalytic volume 306 of the catalyst block is disposed along the center axis of the catalyst block 301. The inner catalytic volume 306 can form a first pathway for the first pass of the exhaust gas, allowing the gas to flow from the upstream terminal to the downstream terminal.

During the first pass of the exhaust gas, the sensible thermal energy from the combustion can warm up the catalyst in the inner catalytic volume 306 gradually and active the catalytic converter as shown below, as examples:

CxHy+O2→CO2+H2O (1)

2CO+O2→CO2 (2)

Both reactions (1) and (2) are oxidation reactions that release chemical reaction energy. As a result, the exhaust gas can increase in temperature as the reactions proceed. As a result, the combined thermal energy and the newly-released chemical reaction energy can gradually increase the catalyst temperature of the inner catalytic volume 306.

Furthermore, thorough conductive heat transfer, the combined sensible and chemical reaction heat from the inner catalytic volume 306 can radiate thermal energy into areas next to it and increase those areas' temperature. As shown in FIG. 3, an outer catalytic volume 310 of the catalyst block 301, wrapping the inner catalytic volume 306, can be preheated by the inner catalytic volume 306 during the first pass.

According to some embodiments, the catalyst core can adopt a ceramic monolith with a honeycomb structure. According to some embodiments, the catalyst core can be a metallic foil monolith. As the exhaust gas flow through the honeycomb structure of the catalyst support/core in the early pass, the unevenly distributed hydrocarbons, e.g., the early HC or the late HC during an exhaust stroke, can get blended evenly for the later passes, which improves the catalyst's efficiency.

According to some embodiments, a mixing chamber 308 can be disposed at the terminal side or downstream terminal of the inner catalytic volume 306. The optional mixing chamber 308 can take a geometry that is sized to encourage the blending of the exhausted gas. The size of the mixing chamber 308 can be smaller, equal, or larger than the volume needed to support one trapped-mass worth of exhaust. According to some embodiments, the size of the mixing chamber 308 can be larger than the cylinder displacement volume because the hot exhaust gas expands in volume.

According to some embodiments, the mixing chamber 308 can be shaped to enable a complete 180-degree turn or U-turn of the exhaust gas after the first pass. For example, as shown in FIG. 3, the mixing chamber 308 can be two coupled spheres that can facilitate the air dynamics of the U-turn, allowing the returned exhaust gas to enter two air pathways in the outer catalytic volumes 310. According to some embodiments, the face-mounted catalyst substrate can be added to the inner wall of the mixing chamber to maximize the catalytic conversion.

After the exhaust reverts within the mixing chamber 308, it can enter the preheated outer catalytic volumes 310 for more catalytic reactions in a second pass. The outer catalytic volumes 310, as shown in FIG. 3, can be disposed between the inner catalytic volume 306 and the inner wall of the elongated converter housing 302. According to some embodiments, the catalytic volumes 310 could have possibly reached its light-off temperature, e.g., 250-300° C. for two-way catalysts, before the second pass. In addition, after being heated up in the first pass, the exhaust gas entering the second pass can be significantly hotter than before. As a result, the reaction rate in the outer catalytic volumes 310 can get accelerated, leading to an overall improved efficiency of the catalyst block 301. Furthermore, due to the bi-directional conductive heat dissipation, the heat accumulated in the outer catalytic volumes 310 can reciprocally keep the inner catalyst volume warm.

According to embodiments, instead of first entering the catalyst block 301 via the center, the exhaust gas can enter the block via the outside diameter, or the outer catalytic volumes 310, in the first pass. After taking a U-turn close to the downstream terminal, the exhaust gas can return to the second pass via the inner catalytic volume 306.

According to some embodiments, the catalyst block 301 can be a homogenous catalyst that contains the same type and density of catalyst support or core, washcoat, and precious catalyst metals. According to some embodiments, the divided catalytic volumes, e.g., 306 and 310, can respectively adopt suitable specifications in catalyst support, washcoat and catalyst to maximize the preferred mixing and heating effects.

For example, the first air pathway and reaction channel, e.g., the inner catalytic volume 306, can adopt a more porous catalyst support, e.g., a permeable ceramic monolith, to facilitate the flow of the exhaust gas with less net backpressure. For example, the inner catalytic volume 305 in the first pass can be 200 CPSI (cell per square inch). In contrast, the outer catalytic volume or later catalytic volumes in the later passes can be 300 CPSI.

Similarly, different types and density of precious catalyst metals can be utilized in different catalytic volumes or chambers. For example, the later catalytic volumes can utilize higher density precious metal catalysts, e.g., Pt or Pd, than an early volume to obtain optimized catalyst efficiency.

According to some embodiments, the exhaust gas, after the duel-pass conversion, can exit the converter housing via an outlet pipe 312. The outlet pipe 312, as a part of the exhaust system, can connect to a muffler assembly (not shown).

According to some embodiments, a mixing chamber (not shown) can be disposed closed to the upstream terminal so that the exhaust gas can be mixed before entering the inner catalytic volume 306.

The present disclosure can apply to both a two-way catalyst and a three-way catalyst, or any after-treatment systems that utilize the catalytic reaction mechanisms. For example, in a three-way catalyst, a first pass of the exhaust gas can be through an Rd catalyst for NOx removal, and later passes can be through a Pd/Pt catalyst for CO and HC removal.

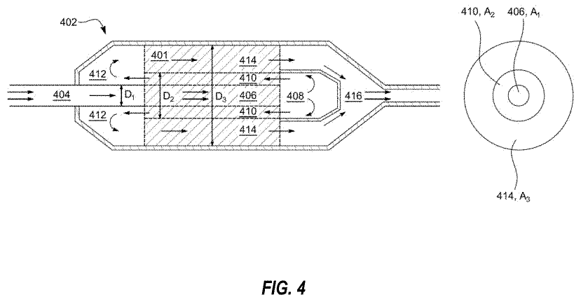

FIG. 4 illustrates a tri-pass catalytic converter 400 according to some embodiments of the present disclosure. According to some embodiments, a tri-pass catalytic converter 400 comprises a catalytic block 401 disposed in an elongated converter housing 402. The elongated converter housing 402 has an upstream terminal and a downstream terminal. The exhaust gas from an IC engine can enter the converter 400 via an inlet pipe 404 at the upstream terminal and exit the converter via an outlet pipe 416 close to the downstream terminal.

According to some embodiments, a heat shield (not shown) can cover all or part of the elongated converter housing 402. The heat shield can prevent undesired thermal loss of the catalyst and protect nearby components from overheating.

According to some embodiments, the catalytic block 401 can be divided into three catalytic volumes: a first catalytic volume 406 (A1) with a first diameter D1, can be disposed along a center axis of the catalyst block 401; a second catalytic volume 410 (A2) with a second diameter D2, can be sandwiched between the first catalytic volume 401 (A1) and a third catalytic volume 414 (A3), which is associated with an outside diameter D3 of catalyst block 410.

According to some embodiments, flow areas are maintained, for example, such that:

D12=Amult_1*(D22−D12)=Amult2*(D32−D22) (3)

Where D1 is the diameter of A1, D2 is outside diameter (OD) of A2, and D3 is outside diameter (OD) of catalyst block 410, and Amult_1 and Amult_2 are area multipliers to allow higher/lower flow velocity between each section.

As shown in FIG. 4, the inlet pipe 404 with an exhaust opening in close or direct contact with a surface of the catalytic block 401, can define the first air pathway for the first pass. During the first pass, through conductive heat transfer, the sensible thermal energy along with the chemical reaction energy can increase the temperature of the second catalytic volumes 410. It is likely that the emitted heat can further preheat the third catalytic volumes 414. As a result, the second catalytic volumes 410 and the third catalytic volumes 414 can get warmed up before the gas passage. According to some embodiments, the second catalytic volume 410 or later catalytic volumes can have reached its light-off temperature, e.g., 250-300° C. for two-way catalysts.

According to some embodiments, one or more mixing chambers can facilitate the reversions of the exhaust gas. As shown in FIG. 4, a first mixing chamber 408 can be disposed at the terminal side of the first catalytic volume 406. The first mixing chamber 408 can adopt a geometry configured to encourage the mixing of the exhausted gas. According to some embodiments, the first mixing chamber 408 can be shaped to enable a complete U-turn of the exhaust gas to enter a second pass via the second catalytic volumes 410. For example, the shape of the first mixing chamber 408 can define the diameter D2 of the second catalytic volumes 410.

After the reversion within the first mixing chamber 408, the exhaust gas can enter the preheated second catalytic volumes 410 for more catalytic reactions in a second pass. According to some embodiments, the exhaust gas, after the first pass, can be hotter than before. As the catalyst in the second catalytic volumes 410 and the reactants are hotter, the reaction rate within the second catalytic volumes 410 can be substantially higher. Similarly, the thermal energy emitted in the second catalytic volumes 410 can preheat the third catalytic volumes 414 before gas passage. On the other hand, this thermal energy can keep the first catalytic volume 406 warm in return.

As shown in FIG. 4, a second mixing chamber 412 can be adopted to facilitate the second reversion of the exhaust gas. The second mixing chamber 412, disposed around the inlet pipe 401, can have a geometry and size that enable the mixing and reversion of the exhaust gas. For example, a diameter of s the second mixing chamber 412 is similar to the outside diameter D3 of the catalytic block 401.

After the second reversion within the second mixing chamber 412, the exhaust gas can enter the preheated third catalytic volumes 414 for more catalytic reactions. After exiting the third catalytic volumes 414, the exhaust gas can exit the converter via an outlet pipe 416.

According to some embodiments, the catalyst block 401 can be a homogenous catalyst that contains the same type and density of materials. According to some embodiments, the divided catalytic volumes, e.g., 406, 410, and 414, can individually adopt its respective material specifications in catalyst support, washcoat, and catalyst to maximize the said mixing and heating effects.

For example, the first air pathway and reaction channel, e.g., the first catalytic volume 406, can adopt a porous catalyst support to reduce net backpressure. For example, the first catalytic volume 406 can be 200 CPSI (cell per square inch), whereas the second or third catalytic volume can be 300 CPSI.

Similarly, different types and density of precious catalyst metals can be utilized in different catalytic volumes or regions. For example, the later catalytic volumes can utilize higher density precious metal catalysts, e.g., Pt or Pd, than an early catalytic volume as the conversion efficiency is higher in the later passes.

According to some embodiments, the multi-pass catalytic converter can be more than three passes. e.g., four or more passes, as long as it maintains the benefits without excessive side effects, e. g., overheating of the catalyst or weak pressure of the exhaust gas. Furthermore, the multi-pass catalytic converter can adopt an incomplete half pass, e.g., or two and a half pass, if needed.

In addition, the present disclosure can apply to both a two-way catalyst and a three-way catalyst, or any after-treatment systems of similar mechanisms.

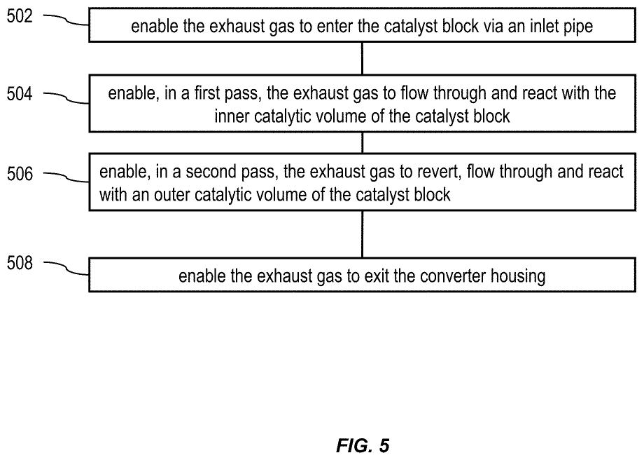

FIG. 5 is an example flow diagram illustrating one embodiment of the present subject matter. According to some embodiments, a dual-pass catalytic converter can include a catalyst block placed in an elongated converter housing. The catalyst block can be divided into an inner catalytic volume, and an outer catalytic volume, wherein a diameter of the inner catalytic volume is smaller than a diameter of the catalyst block.

At step 502, the dual-pass catalytic converter can enable the exhaust gas to enter the catalyst block via an inlet pipe. According to some embodiments, the inlet pipe can be substantially in close contact with a surface of the inner catalytic volume so that the exhaust gas can flow through the catalyst block via an air path defined by the shape and size of the inlet pipe.

According to some embodiments, the inlet pipe can be disposed along a center axis of the catalyst block. Accordingly, an inner catalytic volume of the catalyst block is disposed along the center axis of the catalyst block. The inner catalytic volume can form a first pathway for the first pass of the exhaust gas, allowing the gas to flow from an upstream terminal to a downstream terminal of the converter.

At step 504, the dual-pass catalytic converter is configured to enable, in a first pass, the exhaust gas to flow through and react with the inner catalytic volume. According to some embodiments, the combined sensible thermal energy and the chemical reaction energy released in the first pass can preheat the outer catalytic volume so that its light-off time can be reduced.

According to some embodiments, the dual-pass catalytic convert can further comprise a mixing chamber at the terminal side of the inner catalytic volume. The mixing chamber can facilitate a 180-degree turn or U-turn of the exhaust gas after the first pass. According to some embodiments, the mixing chamber can have an additional catalyst coating to maximize catalytic conversion.

At step 506, the dual-pass catalytic converter can enable, in a second pass, the exhaust gas to revert, flow through, and react with the outer catalytic volume. According to some embodiments, the outer catalytic volume can be disposed between the inner catalytic volume and the inner wall of the elongated converter housing. According to some embodiments, after being heated up in the first pass, the exhaust gas entering the second pass can be hotter before. As the catalyst in the outer catalytic volume has been preheated, and the exhaust gas is hotter, the reaction temperature and rate of the outer catalytic volume can be substantially higher. This can result in improved efficiency of the catalyst block. Furthermore, due to the bi-directional conductive heat dissipation, the heat accumulated in the second pass can keep the inner catalytic volume warm in return.

According to embodiments, instead of first entering the catalyst block at the center, the exhaust gas can enter the block via the outer catalytic volume in the first pass. After taking a U-turn close to the downstream terminal, the exhaust gas can return to the second pass via the inner catalytic volume.

At step 508, the dual-pass catalytic converter can enable the exhaust gas to exit the converter housing and enter, for example, a muffler assembly.

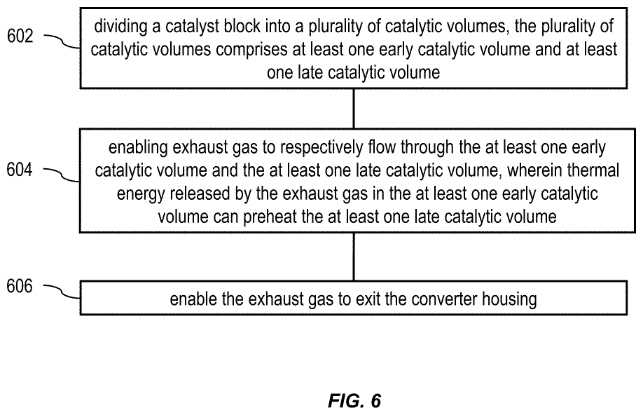

FIG. 6 is another example flow diagram 600, illustrating one embodiment of the present subject matter. According to some embodiments, at step 602, a method of thermal management in a multi-pass catalytic converter comprises dividing a catalyst block into a number of catalytic volumes, including at least an early catalytic volume and a late catalytic volume. According to some embodiments, the catalyst block can be divided into a first catalytic volume, a second catalytic volume, and a third catalytic volume.

At step 604, the method further comprises enabling exhaust gas to first flow through the at least one early catalytic volume and consecutively flow through the at least one late catalytic volume. During the early pass, through conductive heat transfer, the thermal energy in the at least one early catalytic volume can increase the temperature of the at least one late catalytic volume. As a result, the at least one late catalytic volume can get preheated or even reach its catalyst light-off temperature before the gas passage.

Furthermore, according to some embodiments, one or more mixing chambers can be adapted to facilitate the one or more reversion of the exhaust gas. The shape and size of the mixing chamber are configured to maximize the reversion of the exhaust gas without excessive pressure loss.

At step 606, the method further comprises enabling the exhaust gas to exit the converter housing via an outlet pipe connecting to a muffler assembly.

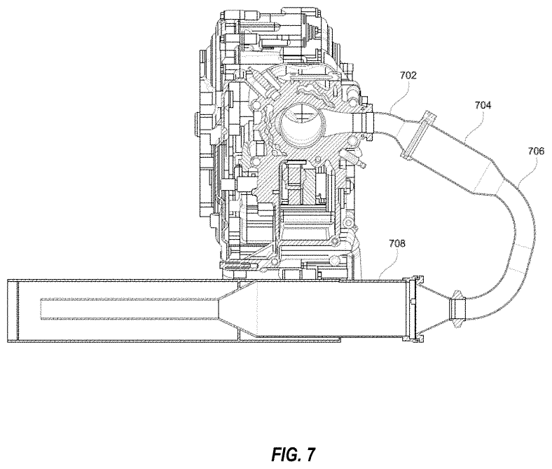

FIG. 7 illustrates an embodiment of a multi-pass catalytic convert in connection with an internal combustion engine and a muffler system. As shown in FIG. 7, a multi-pass catalytic converter 704 can be coupled to an inlet pipe 702 and an outlet pipe 706, which is connected to a muffler assembly 708. According to some embodiments, exhaust gas, e.g., unburned HC, CO, and NOx, from the lean-burn opposed piston engine can enter the multi-pass catalytic converter 704 via the inlet pipe 702. After the multi-pass conversion, the treated exhausted gas can enter the muffler assembly 708 and later be released to the atmosphere. The layout of the listed components are exemplary and not limiting. For example, the outlet pipe 706 can be arranged next to the inlet pipe 702.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. The described features and steps are disclosed as examples of components of systems and methods within the scope of the appended claims.

What is claimed is:

1. A multi-pass catalytic converter for treating exhaust gas of an internal combustion engine, comprising:
an elongated converter housing having an upstream terminal and a downstream terminal;
a catalyst block disposed in the elongated converter housing, the catalyst block having a first diameter; and
an inlet pipe being substantially in close contact with a surface of an inner catalytic volume of the catalyst block, the inlet pipe having a second diameter that is smaller than the first diameter,
wherein the multi-pass catalytic converter is configured to:
enable the exhaust gas to enter the catalyst block via the inlet pipe at the upstream terminal;
enable, in a first pass, the exhaust gas to flow through and react with the inner catalytic volume of the catalyst block; and
enable, in a second pass, the exhaust gas to revert, flow through, and react with an outer catalytic volume of the catalyst block, the outer catalytic volume being disposed between the inner catalytic volume and the elongated converter housing.

2. The multi-pass catalytic converter of claim 1, wherein, in the first pass, thermal sensible energy from the exhaust gas and chemical reaction energy from conversion reactions in the inner catalytic volume are utilized to increase the temperature of the outer catalytic volume.

3. The multi-pass catalytic converter of claim 2, wherein the outer catalytic volume emits heat to maintain an internal temperature of the inner catalytic volume.

4. The multi-pass catalytic converter of claim 1, wherein the multi-pass catalytic converter is configured to further mix the exhaust gas using one or more mixing chambers before and/or after the inner and outer catalytic volumes to improve the conversion efficiency of the catalytic converter.

5. The multi-pass catalytic converter of claim 1, wherein the inner catalytic volume is disposed along a center axis of the elongated converter housing, and wherein the outer catalytic volume is disposed between the inner catalytic volume of the catalyst block and the elongated converter housing.

6. The multi-pass catalytic converter of claim 1, wherein the multi-pass catalytic converter is further configured to:
enable the exhaust gas to exit the elongated converter housing via an outlet pipe at the downstream terminal.

7. The multi-pass catalytic converter of claim 1, further comprising:
a mixing chamber disposed at the downstream terminal of the elongated converter housing, the mixing chamber configured to revert and mix the exhaust gas after the first pass.

8. The multi-pass catalytic converter of claim 1, wherein the inner catalytic volume and the outer catalytic volume each has different material specifications.

9. The multi-pass catalytic convert of claim 1, wherein the first pass is in a first flow direction and the second pass is in a second flow direction that is opposite to the first flow direction.

10. A multi-pass catalytic converter for treating exhaust gas, comprising:
an elongated converter housing having an upstream terminal and a downstream terminal;
a catalyst block disposed in the elongated converter housing, the catalyst block comprising a first catalytic volume, a second catalytic volume, and a third catalytic volume; and
an inlet pipe being substantially in close contact with a surface of the first catalytic volume,
wherein the multi-pass catalytic converter is configured to:
enable exhaust gas to enter the catalyst block via the inlet pipe at the upstream terminal;
enable, in a first pass, the exhaust gas to flow through and react with the first catalytic volume;
enable, in a second pass, the exhaust gas to revert, flow through, and react with the second catalytic volume; and
enable, in a third pass, the exhaust gas to revert, flow through, and react with the third catalytic volume of the catalyst block.

11. The multi-pass catalytic converter of claim 10, wherein sensible thermal energy and chemical reaction energy released in the first catalytic volume are utilized to preheat at least one of the second catalytic volume and the third catalytic volume.

12. The multi-pass catalytic converter of claim 10, wherein the multi-pass catalytic converter is further configured to:
enable the exhaust gas to exit the elongated converter housing via an outlet pipe.

13. The multi-pass catalytic convert of claim 10, wherein the first pass and the third pass are in a first flow direction, and the second pass is in a second flow direction that is opposite to the first flow direction.

14. The multi-pass catalytic converter of claim 10, further comprising:
one or more mixing chambers before and/or after the first catalytic volume, the second catalytic volume and the third catalytic volume, the one or more mixing chambers configured to revert and mix the exhaust gas.

15. The multi-pass catalytic converter of claim 10, wherein the first catalytic volume is disposed along a center axis of the elongated converter housing, and the second catalytic volume is sandwiched between the first catalytic volume and the third catalytic volume.

16. A method of thermal management in a multi-pass catalytic converter, comprising:
dividing a catalyst block into a plurality of catalytic volumes, the plurality of catalytic volumes comprises at least one early catalytic volume and at least one late catalytic volume; and
enabling exhaust gas to flow through the at least one early catalytic volume and the at least one late catalytic volume respectively, wherein thermal energy released in the at least one early catalytic volume can preheat the at least one late catalytic volume to reduce its light-off time.

17. The method of thermal management of claim 16, wherein the thermal energy released by the exhaust gas comprises thermal sensible energy of the exhaust gas and the chemical reaction energy in the at least one early catalytic volume.

18. The method of thermal management of claim 16, further comprising:
enabling the exhaust gas to be thoroughly mixed via one or more mixing chambers.
